(19) United States
(12) Patent Application Publication
(10) Pub. No.: US 2022/0335082 A1
(43) Pub. Date: Oct. 20, 2022

(54) METHOD FOR AUDIO TRACK DATA RETRIEVAL, METHOD FOR IDENTIFYING AUDIO CLIP, AND MOBILE DEVICE

(71) Applicant: GUANGDONG OPPO MOBILE TELECOMMUNICATIONS CORP., LTD., Dongguan (CN)

(72) Inventor: Jenhao HSIAO, Palo Alto, CA (US)

(21) Appl. No.: 17/810,059

(22) Filed: Jun. 30, 2022

Related U.S. Application Data
(63) Continuation of application No. PCT/CN2020/131125, filed on Nov. 24, 2020.
(60) Provisional application No. 62/956,992, filed on Jan. 3, 2020.

(51) Int. Cl. G06F 16/61; G06F 16/63

(52) U.S. Cl. CPC G06F 16/61; G06F 16/63

(57) ABSTRACT

A method for audio track data retrieval, a method for identifying an audio clip, and a mobile device are provided. In the method for audio track data retrieval, audio track data corresponding to at least a portion of an audio track is obtained, the audio track data is transformed from a first domain into a second domain based on a transform function to generate a representation of the audio track data in the second domain over the time frame, multiple peak values in multiple portions of the representation are detected, multiple identifiers are extracted from the representation based on the multiple peak values, each of the multiple identifiers is hashed with a hash function to produce a hash value for each identifier, and each hash value is associated with one of multiple buckets that share a common feature with the hash value.

### CROSS-REFERENCE TO RELATED APPLICATION (S)

This application is a continuation of International Application No. PCT/CN2020/131125, filed Nov. 24, 2020, which claims priority to U.S. Provisional Application No. 62/956,992, filed Jan. 3, 2020, the entire disclosures of which are incorporated herein by reference.

### TECHNICAL FIELD

The disclosed teachings generally relate to an audio search engine. More particularly, the disclosed teachings relate to an audio search engine that can reliably search a database of songs to identify a particular song that accurately matches a song clip included in a search query.

### BACKGROUND

A search engine involves a program that searches for and identifies items in databases that correspond to features specified in a query by a user. An audio search engine performs searches for audio track data (e.g., complete songs or song clips) in databases. Audio track data can include analog sound waves that are coded in digital form. An example of audio track data includes voice recordings or music recordings (e.g., songs), which can be rendered with a speaker.

A conventional music search engine usually uses metadata to find matching songs. For example, a user must input terms such as an artist, song title, or lyrics that can be searched against matching features in databases of songs. In many instances, a text-based search engine is neither convenient nor user friendly. As such, it would be convenient if a music search engine could efficiently search databases for songs that match an audio song clip. For example, it would be useful if a song clip captured by a microphone could be used to identify a matching song in databases of millions of songs.

There is currently no computationally efficient way to search through numerous songs to rapidly identify a song that matches is song clip. Instead, the number of music tracks continues to grow and, as a result, conventional searching grows more computationally impractical, especially due to noise in sound clips captured by a microphone and due to using sound clips of variable lengths. For example, search systems require lengthy song clips to obtain accurate results, which is impractical because lengthy song clips require more time to search a database of millions of songs. In contrast, searching a shorter song clip would improve search time but result in numerous false positives. Accordingly, a need exists to rapidly search through numerous audio tracks to identify an audio track that accurately matches a sound clip of any length.

### SUMMARY

In a first aspect, a method for audio track data retrieval is provided. The method includes the following. Audio track data corresponding to at least a portion of an audio track is obtained, where the audio track data spans over a time frame. The audio track data is transformed from a first domain into a second domain based on a transform function to generate a representation of the audio track data in the second domain over the time frame. Multiple peak values in multiple portions of the representation are detected, where the multiple portions are non-overlapping areas of the representation. Multiple identifiers are extracted from the representation based on the multiple peak values, where each identifier represents an area of the representation. Each of the multiple identifiers is hashed with a hash function to produce a hash value for each identifier. Each hash value is associated with one of multiple buckets that share a common feature with the hash value, where the multiple buckets are adapted to uniformly distribute hash values among the multiple buckets. The hash value for each identifier of the audio track data is processed, so as to enable audio track data retrieval based on the hash value relative to the multiple buckets.

In a second aspect, a method for identifying an audio clip is provided. The method includes the following. A query including a first audio clip is received, where the first audio clip is input to a user device. The first audio clip is processed to generate a representation of a spectrum of frequencies of the first audio clip as it varies with time. Multiple identifiers are extracted from the representation, where each identifier includes multiple peak values of the spectrum of frequencies. Identifier data of the first audio clip is compared to identifier data of multiple audio clips. The identifier data of the first audio clip is matched to identifier data of a second audio clip of the multiple audio clips. An indication of the second audio clip is output as a search result that satisfies the query.

In a third aspect, a mobile device is provided. The mobile device includes a processor, a memory including processor executable code, a microphone, a speaker, and a display. The processor executable code upon execution by the processor configures the processor to: receive a query including a first audio clip, where the first audio clip is input to a user device, process the first audio clip to generate a representation of a spectrum of frequencies of the first audio clip as it varies with time, extract multiple identifiers from the representation, where each identifier includes multiple peak values of the spectrum of frequencies, compare identifier data of the first audio clip to identifier data of multiple audio clips, match the identifier data of the first audio clip to identifier data of a second audio clip of the multiple audio clips, and output an indication of the second audio clip as a search result that satisfies the query. The microphone, display, and speaker are each coupled to the processor and configured to capture audio, display search results, and render the first audio clip or the second audio clip to a user.

### BRIEF DESCRIPTION OF THE DRAWINGS

FIG. 1 depicts a block diagram that illustrates a process for identifying audio track data by matching audio clip data to a corresponding data in a database of numerous audio tracks.

FIG. 2 is a flowchart that illustrates an example of a process for generating a representation of audio track data.

FIG. 3 depicts an example of a representation of audio track data.

FIG. 4 is an example of a graph that illustrates a random data projection of hash data.

FIG. 5 is a graph that illustrates a compact data projection of an adaptive multiple hash (AMH).

FIG. 6 is a flowchart that illustrates a process for maintaining a database of audio tracks.

FIG. 7 is a flowchart that illustrates processes for audio track retrieval.

FIG. 8 is a block diagram that illustrates an example of a processing system in which at least some operations described herein can be implemented.

### DETAILED DESCRIPTION

The disclosed techniques can be implemented in various search systems to efficiently search for a particular audio track in databases of numerous audio tracks. For example, a user can submit a query with a sound signal corresponding to a portion of an audio track (also referred to herein as an audio clip). To perform a rapid search operation that is computationally efficient and provides accurate search results, representations of audio track data are utilized for searching. For example, a variety of audio tracks are transformed from a first domain into representations that include unique identifiers (also referred to herein as audio fingerprints) in a second domain. A query that includes an audio clip is similarly transformed into a representation of the second domain and includes an identifier, which can be matched to an audio track. Further, the identifiers can be processed with an adaptive hashing algorithm to accelerate searching for an audio track that matches an audio clip.

In one example, a representation of an audio track or portion thereof (also referred to herein collectively or individually as “audio track data”) is a spectrogram with patterns of peak values of a dimension of the spectrogram. A combination of peak values can function as an identifier of the audio track data. The representation can undergo adaptive hashing to reduce the size of the identifiers of the audio track data in the second domain. In one example, a user device can capture an audio clip that is input to an audio search engine. The audio clip may be a song clip, which is a portion of the song. The audio search engine can identify the transformed sound clip by creating hash values of unique identifiers extracted from the transformed song clip and matched to identifiers of a particular song that was similarly transformed.

The disclosed techniques have various advantages over prior audio search systems to efficiently search through a database of numerous audio tracks for a particular audio track that has a portion matching an audio clip submitted in a query. The disclosed solution is noise and distortion resistant, computationally efficient, and massively scalable. For example, an audio search engine can use unique identifiers of transformed audio track data to accurately identify audio tracks and use a hashing mechanism to accelerate search operations.

A unique identifier can include a combination of values derived from an unidentified audio signal. The combination of values is used to search for a matching combination of values in a known audio signal. The combination of values may refer to a group or pattern of values in a designated area of a representation of audio track data. The unique combination of peak values functions as an audio fingerprint that can uniquely identify audio track data. Further, the disclosed solution can use an “adaptive multiple hash” process that can compress an identifier into a more compact representation, thereby greatly boosting search efficiency. For example, the search times based on an audio clip could be on the order of a few milliseconds per query, even when the query is applied to a massive music database of numerous audio tracks.

To aid in understanding, this description details one example of the disclosed solution as a music search engine that can flexibly search for songs based on song clips of variable lengths that can be input to the search engine. The music search engine is capable of quickly recognizing a matching song track based on a short segment of music captured through, for example, a microphone of a cellular phone. As a result, the music search engine can provide robust music identification in the presence of significant noise and distortions.

However, the disclosed embodiments are not so limited. For example, the audio search engine can process any sound signal to identify matching audio track data or a source of the sound signal (e.g., voice recognition). The disclosed techniques could also apply to search engines for other media such as images, video, etc. For example, the embodiments described herein can include search engines for movies based on movie clips (e.g., movie recognition), or for images based on portions of an image (e.g., image recognition). Accordingly, although this disclosure focuses on a process to generate music identifiers, the disclosed techniques would be similarly applicable to any media with similar properties.

The following description provides specific details for a thorough understanding and an enabling description of these embodiments. One would understand, however, that the embodiments can be practiced without many of these details. Additionally, some well-known structures or functions may not be shown or described in detail for the sake of brevity. The terminology used in the description presented below is intended to be interpreted in its broadest reasonable manner, even though it is being used in conjunction with a detailed description of certain specific embodiments of the invention.

Although not required, embodiments are described below in the general context of computer-executable instructions, such as routines executed by a general-purpose data processing device, e.g., a networked server computer, mobile device, or personal computer. One will appreciate that the invention can be practiced with other communications, data processing, or computer system configurations, including: Internet appliances, handheld devices, wearable computers, all manner of cellular or mobile phones, multi-processor systems, microprocessor-based or programmable consumer electronics, set-top boxes, network PCs, mini-computers, mainframe computers, media players and the like. Indeed, the terms “computer,” “server,” and the like are generally used interchangeably herein, and refer to any of the above devices and systems, as well as any data processor.

While aspects of the disclosed embodiments, such as certain functions, can be performed exclusively or primarily on a single device, some embodiments can also be practiced in distributed environments where functions or modules are shared among disparate processing devices, which are linked through a communications network, such as a local area network (LAN), wide area network (WAN), or the Internet. In a distributed computing environment, program modules can be located in both local and remote memory storage devices.

Aspects of the invention can be stored or distributed on tangible computer-readable media, including magnetically or optically readable computer discs, hardwired or preprogrammed chips (e.g., EEPROM semiconductor chips), nanotechnology memory, biological memory, or other data storage media. In some embodiments, computer implemented instructions, data structures, screen displays, and other data under aspects of the invention can be distributed over the Internet or over other networks (including wireless networks), on a propagated signal on a propagation medium (e.g., an electromagnetic wave(s), a sound wave) over a period of time, or they can be provided on any analog or digital network (packet switched, circuit switched, or other scheme).

General Overview

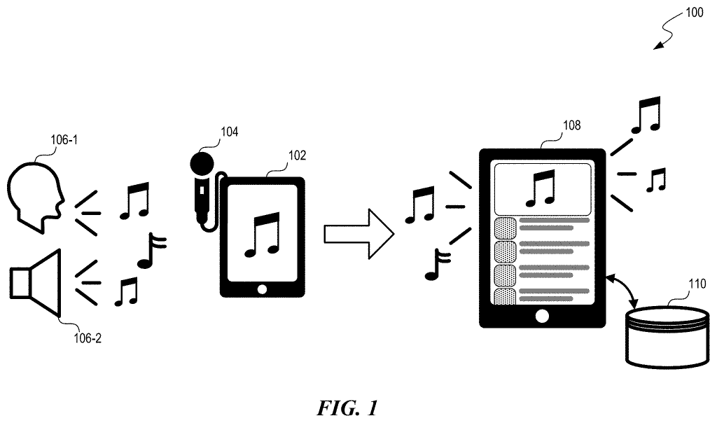

FIG. 1 depicts a block diagram that illustrates a process for identifying audio track data by matching audio clip data to a corresponding data in a database including numerous audio tracks. As shown, an electronic device 102 (e.g., smartphone, tablet computer) is coupled to a microphone 104 that can listen for sounds in an environment. The microphone 104 can receive audio signals including a variety of audio clips as input from a variety of sources and in a variety of forms. The audio signals may also include undesired background noise.

For example, a portion of a song that is being sung by an individual 106-1 is captured by the microphone 104 of the electronic device 102. In another example, a portion of a song that is output by a speaker 106-2 is captured by the microphone. In another example, a song clip is obtained by the electronic device 102 from a network source. For example, a song clip can be extracted digitally from the digital song file.

The search engine 108 can process the audio clip to find a matching audio track from among numerous audio tracks stored in a database 110 connected to the search engine. As such, the search engine 108 can identify the audio clip as a portion of a particular audio track. For example, a user may be curious to learn the identity of an unknown song that is being played on the radio or sung by a person. The user can capture several seconds of the song by using the microphone 104. The song clip is submitted to a music recognition application via the electronic device 102. The song clip is processed to produce a representation that can converted, at least in part, into one or more compact hash values. The song clip is compared to numerous hashed representations to find the matching song. The music recognition application can then return results including songs associated with hashed representations that match the hashed representations of the song clip. For example, the search results may be displayed on a display of the electronic device 102 as an ordered list of songs that are ranking according to how well a particular song match the sound clip (e.g., highly ranked songs are displayed at the top).

A computationally efficient search to identify a matching audio track from among numerous audio tracks based on a brief audio clip is enabled by converting audio track data into representations that have unique identifiers. Moreover, the identifiers can be processed by an adaptive hash function to produce hash values used to accelerate search operations. For example, a music database (e.g., database 110) containing millions of hash values for popular songs can be used by a matching algorithm to quickly match identifiers of a song clip to identifiers of the popular songs. Data indicative of songs in the database with the highest probability of having matching identifiers is returned to the user as an identification of the song clip.

Creating Representation of Audio Track Data

The disclosed embodiments include a process for producing a representation of audio track data (e.g., a complete audio track or an audio clip). A representation allows for rapid and accurate matching of audio track data. For example, a query can include a song clip and background noise that is captured by a microphone. The captured song signal is transformed from a first domain into a representation of a second domain and include unique identifiers that can be searched against a database of identifiers to rapidly identify a particular song that matches the song clip. Thus, the use of the representation facilitates accurate search results while eliminating the inefficient need to compare raw audio clips to original audio track files.

An example of the representation is a spectrogram, which is a visual representation of the spectrum of frequencies of an audio signal as it varies with time. The spectrogram is processed to detect patterns of peak values of the audio track data. A pattern of peak values is unique such that the representations includes one or more unique identifiers that can be used to identify the audio track data. In some embodiments, a pattern of peak values includes a combination of a cluster or group of peak values. Because a unique pattern of peak values is derived from original audio track data, the audio track data can be identified based on the pattern. In general, an identifier (e.g., audio fingerprint) has unique acoustic characterizations and can be extracted from audio track data by employing at least one of several methods such as Fourier transform techniques, spectral estimation, Mel-frequency cepstral transform, etc.

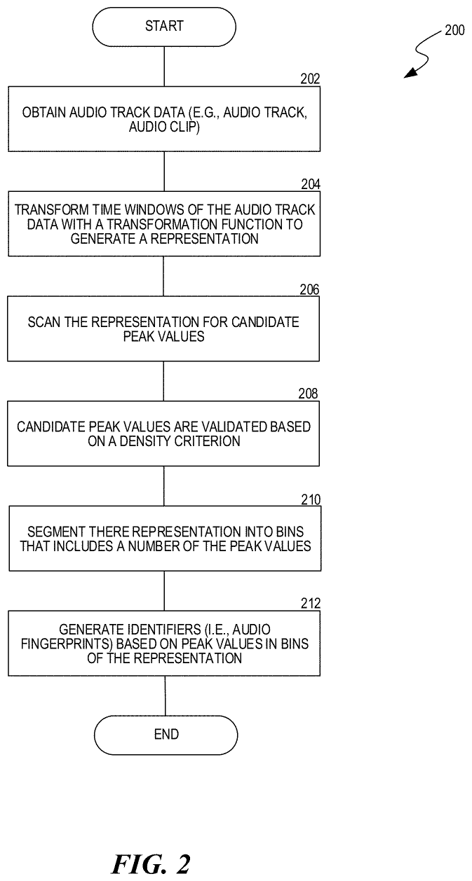

FIG. 2 is an example of a process for generating a representation of audio track data. The process 200 can be performed by a computer system including an audio search engine. In 202, the system can obtain audio track data (e.g., audio track, audio clip) that spans a time-frame. For example, a microphone can capture a song along with background noise in an environment near the microphone. In particular, a user can activate a microphone on the user's smartphone while attending a concert to capture a song clip. In another example, a song clip is digitally extracted from an original song file.

In 204, several time windows of the audio track data are processed by a transformation function such as a Fast Fourier Transform (FFT). A time window typically spans a time period less than the total time frame of the audio track data but could have a time period that is coextensive to the time frame. In some embodiments, the time windows that are processed by the transformation function do not necessarily span the same time period. However, relatively smaller time windows typically produce representations that facilitate more accurate search results compared to larger time windows. The transformation of the audio track data yields a representation such as a spectrogram, which includes a visual representation of the spectrum of frequencies of an audio track data as it varies with time.

To provide robust identification in the presence of background noise and distortions, the spectrogram is further processed to identify features or characteristics that are unique for audio track data. This improves the robustness of representations in the presence of noise and approximate linear superposability, which refers to the ability to bring two particular models into coincidence.

For example, in 206, the system scans the spectrogram for peak values. A candidate peak value is a time-frequency point in the spectrogram that has higher energy compared to neighboring points of a region of the spectrogram. For example, a candidate peak is a point in a spectrogram profile of a song where the candidate point has a higher energy value compared to all neighboring points in a region around the candidate peak.

In 208, candidate peaks are designated as spectrogram peaks according to a density criterion in order to assure that a time-frequency region for the audio track data has reasonably uniform coverage. In some embodiments, a spectrogram peak in each time-frequency locality is chosen according to its amplitude because highest amplitude peaks are more robust to distortions from noise and, as such, more useful for identifying matching peaks in other representations.

In 210, the spectrogram is segmented into frequency bins. Each bin includes a number of peak values that could vary per unique identifier (e.g., audio fingerprint). The number of peaks can vary per bin but each identifier has the same number of bins. More specifically, a bin can have a limited a number of spectrogram peaks, which helps process a spectrogram because the spectrogram peaks that define a window of an identifier can vary.

In 212, an identifier is generated by counting peak values per bin in a designated time period and building a histogram of the count of peak values. The histogram can serve as an identifier for the audio track data. The number of spectrogram peaks of each frequency bin is calculated to build a n-dimensional histogram of frequencies, where each dimension denotes the number of spectrogram peaks at a particular frequency: Fingerprintᵢ=[no. peaks at freq bin₁, . . . , no. of peaks at freq binₙ]

Each unique identifier has the same number of n bins. However, given that the most sensitive limit of human hearing is in about the 2-5 kHz frequency range, using an n equal to or about 5k is a preferred number of frequency bins that can define an identifier (e.g., audio fingerprint) of spectrogram peaks.

A representation can have any number of unique identifiers. Increasing the number of identifiers per audio track data improves the accuracy of identifying matching audio track data; however, increasing the number of identifiers increases the computational burden to search for matching audio track data. In some instances, the number of identifiers can be increased for a time period by overlapping the time-periods of identifiers. By overlapping the time windows of identifiers, more identifiers can be extracted from shorter audio clips to increase the accuracy of a search for matching audio track data.

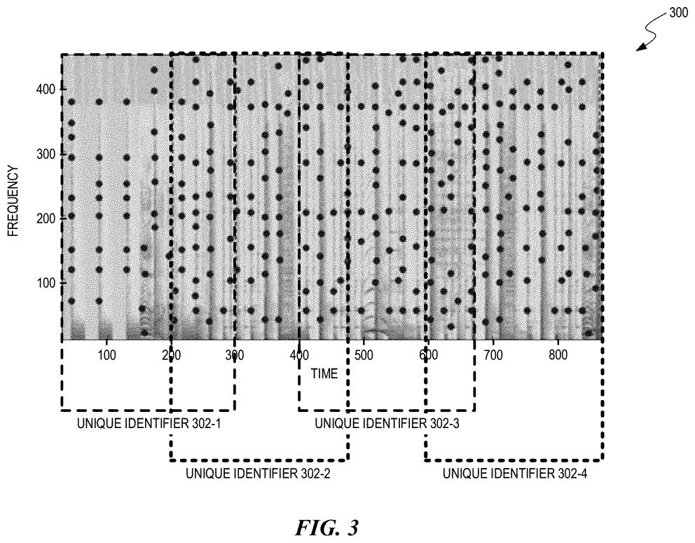

FIG. 3 depicts a representation of audio track data corresponding to a spectrogram 300 of audio track data including a combination of peaks and overlapping identifiers. Specifically, the dots in the spectrogram 300 are spectrogram peaks that are counted per frequency bin to build a histogram that serves as an identifier for the audio track data.

Hashing to Improve Performance

The disclosed embodiments include the use of hashing functions to accelerate search operations to identify matching representations of audio track data. Hashing is a computationally and storage-space efficient form of data access that avoids the non-linear access time of ordered and unordered lists and structured trees. In general, a hash function maps data of arbitrary size to fixed-size values. The values returned by a hash function are used to index a fixed-size table. Common hashing methods include data-independent methods, such as locality-sensitive hashing (LSH) or data-dependent methods, such as locality-preserving hashing (LPH).

The disclosed embodiments can implement a similarity-preserving hash, which is referred to as an adaptive multiple hash (AMH). The AMH function can compress each identifier into fewer bits and build an efficient indexing structure for large scale audio searching at the same time. In particular, the AMH function can associate similar samples to a common bucket with high probability. The system can maintain multiple buckets to for multiple groups of similar audio track data. For example, each bucket can be associated with a particular featyre and all the audio tracks that have the same or similar feature are associated with the bucket. Hence, groups of different audio tracks are grouped into different buckets and each group of similar audio tracks are associated with the same bucket. As such, the property of locality in the original space is largely preserved in the Hamming space for the hash values for the hash values.

Hash methods can use random projections to generate hash bits. For example, LSH places similar input items into the same buckets with high probability. The number of buckets is much smaller than the possible input items. As such, similar input items are placed in a common bucket. Accordingly, this technique can be used for clustering data and to perform a nearest neighbor search, which is a form of proximity search that is optimized to find the point in a given set that is closest (or most similar) to a given point. Hence, LSH can reduce the dimensionality of high-dimensional data. Accordingly, high-dimensional input items can be reduced to low-dimensional versions while preserving relative distances between items. In contrast, for example, a random vector is data-independent. Although there exists an asymptotic theoretical guarantee for random projection based LSH, it is not very efficient in practice because it requires multiple tables with lengthy codes to achieve a sample locality preserving goal.

Unlike other hash methods, AMH uses several techniques to enhance hash performance. More specifically, for any identifier x (e.g., a fingerprint), one can obtain a hash bit h for x with the following hash function:

h(x)=sign(w^{T}*x−t) (1)

Here, w is a projection vector in a feature space, and t is a threshold scalar. For each component of the hash function, the following techniques can optimize the hash performance.

(1) Adaptive Projection for w

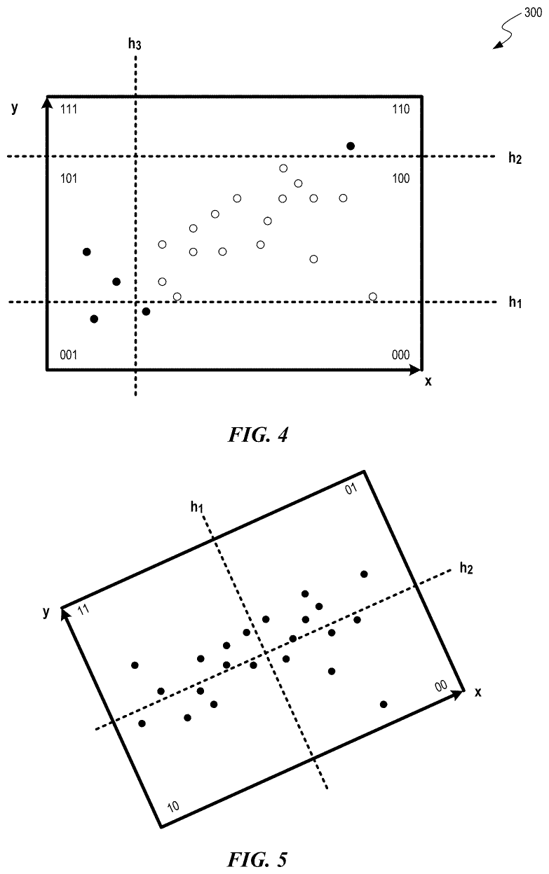

In a real dataset, points may be denser in one dimension (e.g., y direction) compared to another. In the case of an audio track data search, some features may be more sensitive than others in differentiating audio tracks. FIG. 4 is an example of a graph for a random data projection of hash data. The random projection and hash has an extremely unbalanced hash bucket. In particular, FIG. 4 shows six hash buckets 111, 110, 101, 100, 001, and 000 delineated by h₁, h₂, and h₃ functions. As shown, more than 80% of samples (e.g., hollow circles) are hash values in the same bucket 100. As such, a significant increase of search time for some queries is required when numerous comparisons to the hash values in the bucket 100 are required.

To solve the aforementioned problem, the disclosed embodiments transform the audio track data to a new coordinate system such that the greatest variance by some projection of the data comes to lie on the selected coordinates. The resulting feature space can thus partition the hash data more uniformly and effectively. More specifically, finding a linear function w^{T}x of the element x has a maximum variance of:

$${max}_{w , λ} [ {w}^{T} \sum w - λ ( {w}^{T} w - 1 ) ] \qquad ( 2 )$$

This can be obtained by various methods, e.g., singular value decomposition (SVD) where w₁, the largest eigenvector corresponding to λ₁ (the largest eigenvalue of Σ), is the project direction with maximum variance. Similarly, the second greatest variance on the second coordinate and so on (i.e., wᵢ) to serve as the projection vectors and our basic hash functions.

(2) Balanced Threshold for t

Furthermore, balancing a hash bit can improve search performance. As such, choosing tin formula (1) as the median value at the first time of choosing a specific direction wi such that half of each bit are +1, and the other are −1 relative to the medium t. Finally, each n-dimension audio identifier (e.g., total cost of 5,000 dimensions×16 bits (int vector)=80,000 bits per identifier) maps to k-bits by the selected k project directions as:

H(x)=[h₁(x),h₂(x), . . . ,hₖ(x)] (3)

H(x) denotes the hashed audio identifier (k-dimensional fingerprint). In one example, the number of bits (k) is about 64 to 256, which is more than 300 times smaller than the original audio identifier.

For example, FIG. 5 is a graph that illustrates compact data projection of data from FIG. 4 by the disclosed AMH. In particular, FIG. 5 illustrates a uniform data projection relative to the data in FIG. 4. The AMH extracts directions with maximum variance through principal component analysis (PCA) and projects the data into these dimensions for doing data hashing. As a result, the samples are more uniformly bucketized and only two hash functions (i.e., h₁ and h₂) are used.

(3) Multi-Hash Tables and Multi-Probe

It is possible that a nearest neighbor of searchable content fails if that point is hashed to a different bucket. That is, a nearest neighbor search fails because the nearest neighbor is in another bucket. LSH can be used initially to reduce the likelihood of the form of failed nearest neighbor search. First, multiple hash tables are maintained, hashing a point multiple times using different hash functions by using a multi-hash table formulated according to the following formula:

MH(x)={H₁(x),H₂(x), . . . ,Hₘ(x)} (4)

MH(x) contains a set of different hash maps Hₘ(x). The probability that a point and its nearest neighbor are hashed into different buckets for all these hash functions can be reduced by reducing the number of buckets and increasing the number of hash tables. Also, multiple buckets in each hash table are probed within certain Hamming distance thresholds when searching for the nearest neighbor with matching local features, instead of only using a linear scan over the hash bits.

For generating multi-hash tables, densely distributed dimensions should be chosen with lower probability while dimensions with uniformly distributed values should be chosen with higher probability. As such, the probability of selecting dimension i is set in proportion to its distribution variance (e.g., eigenvalues Δᵢ)

$$P ( {w}_{i} ) = \frac{{λ}_{i}}{sum ( λ )} \qquad ( 5 )$$

For example, a random hash map H₁ and H₂ can be generated by:

H₁(x)=[h₁(x),h₂(x),h₅(x),h₇(x),h₉(x)]

H₂(x)=[h₁(x),h₂(x),h₃(x),h₄(x),h₆(x)]

Every hash function h₁ in each hash map is randomly or pseudo randomly picked based on its probabilities (i.e., formula (5)). A “no redundant hash functions rule” can be set in the same hash table to avoid unusual hash bits.

In an illustrative example, an original audio feature such as a Fingerprintᵢ (denoted as fᵢ) is a 5000-dimensional vector. The disclosed AMH function can compress f into a k-dimensional vector: H(fᵢ)=[h₁(x), h₂(x), . . . , hₖ(x)] where k could be 64 through 256. To further improve the accuracy, a multi-hash table can be used: MH(fᵢ)={H₁(x), H₂(x), . . . , Hₘ(x)}, where m is a parameter can trade-off between search speed and accuracy. For example, assume that m=10 and k=64, then the final hashed fingerprint fᵢ will be a 640-dimensional vector.

Building a Database of Audio Tracks

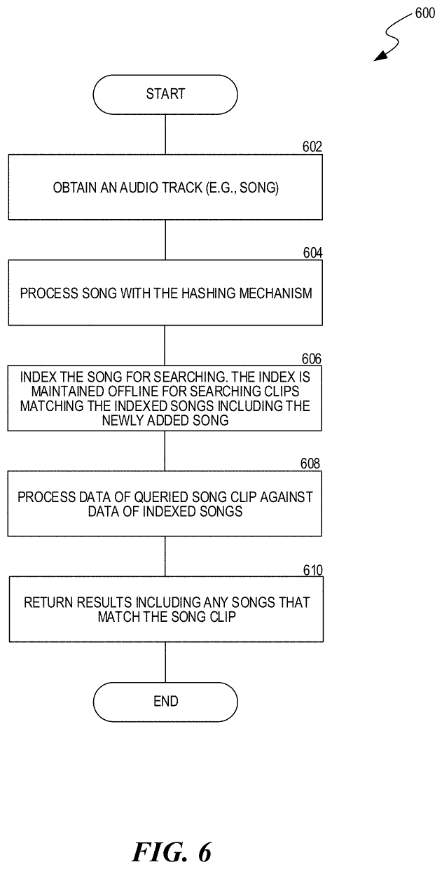

FIG. 6 is a flowchart that shows a process for building a database of audio tracks. The process 600 can be performed to add an audio track to a database. An audio clip included in a query can then be matched to any of the audio tracks in the database including the newly added audio tracks. In 602, an audio track is obtained by the audio search engine. For example, a song can be uploaded to a database of the audio search engine.

In 604, the audio track is processed to generate its representation and then process by the hashing mechanism. As such, when each new audio track arrives, the system can compute its identifiers based on the spectrogram peaks and then hashes the identifiers with the AMH.

In 606, the hashed identifiers are indexed in the database. The identifiers can be indexed based on a timestamp that indicates, for example, when the audio track was created or received for processing. In another example, the audio track is indexed according to another metric or metadata associated with the audio track. Hence, the identifiers of the audio track can be indexed across a common metric for all the song. As such, the index can be maintained offline for searching of audio clips by the audio search engine.

In 608, a queried audio clip can be processed to search its unique identifiers against an index of identifiers for audio tracks. That is, once identifiers of the queried clip are determined, a matching process is performed (e.g., based on the Hamming distance) where the sequence of query hashes in the identifier is matched against all the reference hashes (e.g., all songs that are indexed offline). In 610, the audio track(s) that match the audio clip with a similarity that exceeds a threshold value is declared as the match for that query.

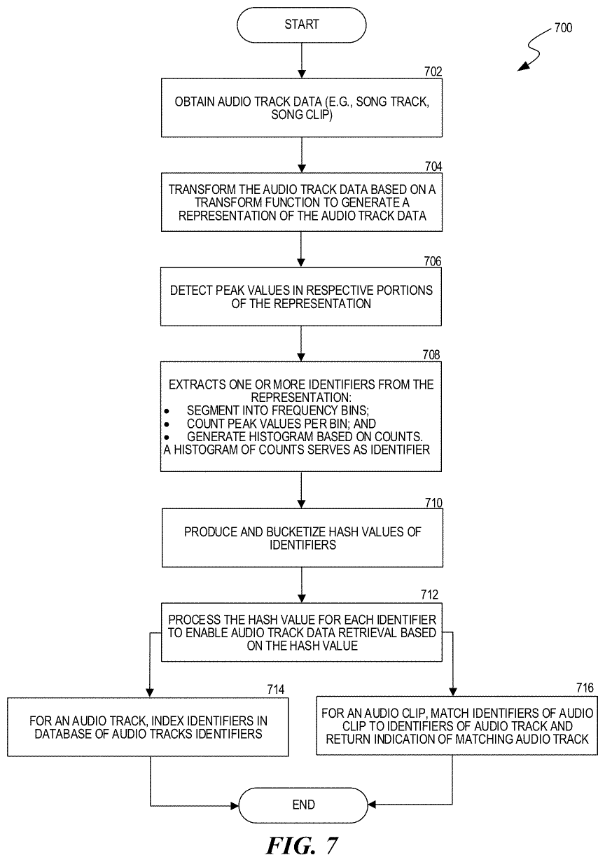

FIG. 7 is a flowchart that illustrates processes for performing audio track retrieval of audio tracks that match an audio clip. The method 700 can be performed by an audio track data retrieval system. In 702, the system can obtain audio track data that corresponds to at least a portion of an audio track (e.g., song track, song clip). For example, the system can receive a query to identify a song that matches a song clip. The song clip can be input to a microphone of an electronic device. The song clip can be a spoken song by a user or output by a nearby speaker. The input normally includes background noise. In another example, the system queries to identify a song that matches a song clip, which was digitally extracted from a song track.

In 704, the system can transform the audio track data in a first domain based on a transform function (e.g., Fast Fourier Transform (FFT)) to generate a representation in a second domain that spans a time frame. The representation can vary over the time frame. An example of the representation is a spectrogram. In some embodiments, the representation is a visual representation of a spectrum of frequencies of the audio track data as it varies with time.

In 706, the system can detect peak values in respective portions of the representation. In some embodiments, the portions are non-overlapping areas of the representation. In some embodiments, each peak is a maximum peak value in a respective portion of the representation. In some embodiments, each peak value exceeds a threshold value in a respective portion of the representation.

In 708, the system extracts one or more unique identifiers from the representation of the audio track data. The identifier is an audio fingerprint. Each identifier includes a combination of peak values. In some embodiments, a combination of peak values uniquely identifies an audio track from other audio tracks.

For example, for each identifier, the system can segment the spectrogram into n-frequency bins that each include peak values. The system can count any peak values in each bin, and generate a histogram based on a number of peak values in the n-frequency bins. The histogram can serve as an identifier for the audio track data. The identifiers of audio track data can each span the same time period and can have overlapping and/or non-overlapping portions.

In 710, the system can hash the identifiers with the AMH function to produce a hash value for each identifier. Further, similar hash values are associated with a common bucket. In some embodiments, the hashing function is adaptive to hash multiple samples into common hash buckets.

In 712, the system can process the hash value for each identifier of the audio track data to enable audio track data retrieval based on the hash value. For example, in 714, when the audio track data is an audio track, the system can process the hash value by indexing the hash value in a library of hash values corresponding to identifiers of audio tracks. In another example, in 716, when the audio track data is an audio clip, the system can perform steps to identify a matching audio track. That is, the system can compare the hash values of the audio clip to hash values stored in a database, wherein each hash value stored in the database corresponds to an identifier of an audio track. The system can determine a distance based on a similarity between a hash value of the audio clip one or more hash values in the database. Then, the system can match at least some of the hash values of the audio clip to hash values of one or more audio tracks in the hash buckets. The system can output an indication of one or more audio tracks that match the audio clip.

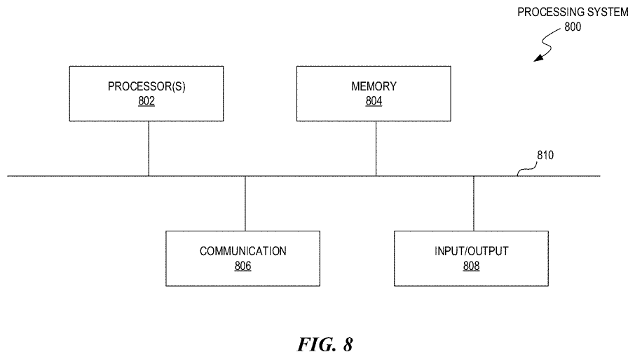

FIG. 8 is a block diagram illustrating an example of a processing system 800 in which at least some operations described herein can be implemented. The processing system 800 represents a system that can run any of the methods/algorithms described herein. For example, any network access device (e.g., user device) component of a network can include or be part of a processing system 800. The processing system 800 can include one or more processing devices, which can be coupled to each other via a network or multiple networks. A network can be referred to as a communication network or telecommunications network.

In the illustrated embodiment, the processing system 800 includes one or more processors 802, memory 804, a communication device 806, and one or more input/output (I/O) devices 808, all coupled to each other through an interconnect 810. The interconnect 810 can be or include one or more conductive traces, buses, point-to-point connections, controllers, adapters and/or other conventional connection devices. Each of the processor(s) 802 can be or include, for example, one or more general-purpose programmable microprocessors or microprocessor cores, microcontrollers, application specific integrated circuits (ASICs), programmable gate arrays, or the like, or a combination of such devices.

The processor(s) 802 control the overall operation of the processing system 800. Memory 804 can be or include one or more a physical storage facilities, which can be in the form of random-access memory (RAM), read-only memory (ROM) (which can be erasable and programmable), flash memory, miniature hard disk drive, or other suitable type of storage device, or a combination of such devices. Memory 804 can store data and instructions that configure the processor(s) 802 to execute operations in accordance with the techniques described above. The communication device 806 can be or include, for example, an Ethernet adapter, cable modem, Wi-Fi adapter, cellular transceiver, Bluetooth transceiver, or the like, or a combination thereof. Depending on the specific nature and purpose of the processing system 800, the I/O devices 808 can include devices such as a display (which can be a touch screen display), audio speaker, keyboard, mouse or other pointing device, microphone, camera, etc.

While processes or blocks are presented in a given order, alternative embodiments can perform routines having steps or employ systems having blocks, in a different order, and some processes or blocks can be deleted, moved, added, subdivided, combined and/or modified to provide alternative or sub-combinations, or can be replicated (e.g., performed multiple times). Each of these processes or blocks can be implemented in a variety of different ways. In addition, while processes or blocks are at times shown as being performed in series, these processes or blocks may instead be performed in parallel, or can be performed at different times. When a process or step is “based on” a value or a computation, the process or step should be interpreted as based at least on that value or that computation.

Software or firmware to implement the techniques introduced here can be stored on a machine-readable storage medium and can be executed by one or more general-purpose or special-purpose programmable microprocessors. A “machine-readable medium”, as the term is used herein, includes any mechanism that can store information in a form accessible by a machine (a machine can be, for example, a computer, network device, cellular phone, personal digital assistant (PDA), manufacturing tool, any device with one or more processors, etc.). For example, a machine-accessible medium includes recordable/non-recordable media (e.g., read-only memory (ROM), random-access memory (RAM), magnetic disk storage media, optical storage media, flash memory devices), etc.

Note that any and all of the embodiments described above can be combined with each other, except to the extent that it may be stated otherwise above, or to the extent that any such embodiments might be mutually exclusive in function and/or structure. Although the present invention has been described with reference to specific exemplary embodiments, it will be recognized that the invention is not limited to the embodiments described but can be practiced with modification and alteration within the spirit and scope of the disclosed embodiments. Accordingly, the specification and drawings are to be regarded in an illustrative sense rather than a restrictive sense.

Physical and functional components (e.g., devices, engines, modules, and data repositories) associated with processing system 800 can be implemented as circuitry, firmware, software, other executable instructions, or any combination thereof. For example, the functional components can be implemented in the form of special-purpose circuitry, in the form of one or more appropriately programmed processors, a single board chip, a field programmable gate array, a general-purpose computing device configured by executable instructions, a virtual machine configured by executable instructions, a cloud computing environment configured by executable instructions, or any combination thereof. For example, the functional components described can be implemented as instructions on a tangible storage memory capable of being executed by a processor or other integrated circuit chip. The tangible storage memory can be computer-readable data storage. The tangible storage memory can be volatile or non-volatile memory. In some embodiments, the volatile memory can be considered “non-transitory” in the sense that it is not a transitory signal. Memory space and storage described in the figures can be implemented with the tangible storage memory as well, including volatile or non-volatile memory.

Each of the functional components can operate individually and independently of other functional components. Some or all of the functional components can be executed on the same host device or on separate devices. The separate devices can be coupled through one or more communication channels (e.g., wireless or wired channel) to coordinate their operations. Some or all of the functional components can be combined as one component. A single functional component can be divided into sub-components, each sub-component performing separate method steps or a method step of the single component.

In some embodiments, at least some of the functional components share access to a memory space. For example, one functional component can access data accessed by or transformed by another functional component. The functional components can be considered “coupled” to one another if they share a physical connection or a virtual connection, directly or indirectly, allowing data accessed or modified by one functional component to be accessed in another functional component. In some embodiments, at least some of the functional components can be upgraded or modified remotely (e.g., by reconfiguring executable instructions that implement a portion of the functional components). Other arrays, systems and devices described above can include additional, fewer, or different functional components for various applications.

Aspects of the disclosed embodiments can be described in terms of algorithms and symbolic representations of operations on data bits stored in memory. These algorithmic descriptions and symbolic representations generally include a sequence of operations leading to a desired result. The operations require physical manipulations of physical quantities. Usually, though not necessarily, these quantities take the form of electric or magnetic signals that are capable of being stored, transferred, combined, compared, and otherwise manipulated. Customarily, and for convenience, these signals are referred to as bits, values, elements, symbols, characters, terms, numbers, or the like. These and similar terms are associated with physical quantities and are merely convenient labels applied to these quantities.

### CONCLUSION

Unless the context clearly requires otherwise, throughout the description and the claims, the words “comprise,” “comprising,” and the like are to be construed in an inclusive sense, as opposed to an exclusive or exhaustive sense; that is to say, in the sense of “including, but not limited to.” As used herein, the terms “connected,” “coupled,” or any variant thereof, means any connection or coupling, either direct or indirect, between two or more elements; the coupling of connection between the elements can be physical, logical, or a combination thereof. Additionally, the words “herein,” “above,” “below,” and words of similar import, when used in this application, shall refer to this application as a whole and not to any particular portions of this application. Where the context permits, words in the above Detailed Description using the singular or plural number can also include the plural or singular number respectively. The word “or,” in reference to a set of two or more items, covers all of the following interpretations of the word: any of the items in the list, all of the items in the list, and any combination of the items in the list.

The above detailed description of embodiments of the system is not intended to be exhaustive or to limit the system to the precise form disclosed above. While specific embodiments of, and examples for, the system are described above for illustrative purposes, various equivalent modifications are possible within the scope of the system. For example, some network elements are described herein as performing certain functions. Those functions could be performed by other elements in the same or differing networks, which could reduce the number of network elements. Alternatively or additionally, network elements performing those functions could be replaced by two or more elements to perform portions of those functions. In addition, while processes, message/data flows, or blocks are presented in a given order, alternative embodiments may perform routines having steps, or employ systems having blocks, in a different order, and some processes or blocks may be deleted, moved, added, subdivided, combined, and/or modified to provide alternative or subcombinations. Each of these processes, message/data flows, or blocks may be implemented in a variety of different ways. Also, while processes or blocks are at times shown as being performed in series, these processes or blocks may instead be performed in parallel, or may be performed at different times. Further any specific numbers noted herein are only examples: alternative implementations may employ differing values or ranges. One will also appreciate that the actual implementation of a database can take a variety of forms, and the term “database” is used herein in the generic sense to refer to any data structure that allows data to be stored and accessed, such as tables, linked lists, arrays, etc.

The teachings of the methods and system provided herein can be applied to other systems, not necessarily the system described above. The elements and acts of the various embodiments described above can be combined to provide further embodiments.

Any patents and applications and other references noted above, including any that may be listed in accompanying filing papers, are incorporated herein by reference. Aspects of the disclosure can be modified, if necessary, to employ the systems, functions, and concepts of the various references described above to provide yet further embodiments of the disclosure.

These and other changes can be made to the invention in light of the above Detailed Description. While the above description describes certain embodiments of the disclosure, and describes the best mode contemplated, no matter how detailed the above appears in text, the invention can be practiced in many ways. Details of the system may vary considerably in its implementation details, while still being encompassed by the technology disclosed herein. As noted above, particular terminology used when describing certain features or aspects of the disclosed techniques should not be taken to imply that the terminology is being redefined herein to be restricted to any specific characteristics, features, or aspects of the disclosed techniques with which that terminology is associated. In general, the terms used in the following claims should not be construed to limit the invention to the specific embodiments disclosed in the specification, unless the above Detailed Description section explicitly defines such terms. Accordingly, the actual scope of the invention encompasses not only the disclosed embodiments, but also all equivalent ways of practicing or implementing the invention under the claims.

While certain aspects of the disclosed techniques are presented below in certain claim forms, the inventors contemplate the various aspects of the techniques in any number of claim forms. For example, while only one aspect of the invention is recited as embodied in a computer-readable medium, other aspects can likewise be embodied in a computer-readable medium.

Accordingly, the inventors reserve the right to add additional claims after filing the application to pursue such additional claim forms for other aspects of the disclosed techniques.

1. A method for audio track data retrieval, comprising:
obtaining audio track data corresponding to at least a portion of an audio track, the audio track data spanning over a time frame;
transforming the audio track data from a first domain into a second domain based on a transform function to generate a representation of the audio track data in the second domain over the time frame;
detecting a plurality of peak values in a plurality of portions of the representation, the plurality of portions being non-overlapping areas of the representation;
extracting, based on the plurality of peak values, a plurality of identifiers from the representation, each identifier representing an area of the representation;
hashing each of the plurality of identifiers with a hash function to produce a hash value for each identifier;
associating each hash value with one of a plurality of buckets that share a common feature with the hash value, the plurality of buckets being adapted to uniformly distribute hash values among the plurality of buckets; and
processing the hash value for each identifier of the audio track data so as to enable audio track data retrieval based on the hash value relative to the plurality of buckets.

2. The method of claim 1, wherein the representation is a spectrogram, and extracting the plurality of identifiers comprises:
for each identifier:
segmenting the spectrogram into n-frequency bins that each include a number of the plurality of peak values;
counting any peak values in each bin; and
generating a histogram based on a number of peak values in the n-frequency bins,
wherein the histogram serves as the identifier for the audio track data.

3. The method of claim 1, wherein the audio track data is an audio track, and processing the hash value comprises:
indexing the hash value corresponding to an identifier of a plurality of audio tracks in one of the plurality of buckets.

4. The method of claim 1, wherein the audio track data is an audio clip, and processing the hash value of the audio clip comprises:
matching the hash value of the audio clip to a hash value stored in a database of hash values, each hash value stored in the database being associated with an audio track; and
outputting an indication of an audio track associated with the hash value stored in the database that matches the hash value of the audio clip.

5. The method of claim 1, wherein the plurality of identifiers each span a common time period and have overlapping portions.

6. The method of claim 1, wherein the plurality of identifiers each span a common time period that are non-overlapping.

7. The method of claim 1, wherein the audio track data corresponds to a song track or a song clip.

8. The method of claim 1, wherein the audio track data is a song clip, and obtaining the song clip comprising:
receiving a query to identify a song that matches the song clip, wherein the query includes the song clip and background noise captured by a microphone of an electronic device.

9. The method of claim 1, wherein the audio track data is a song clip, and obtaining the song clip comprising:
receiving a query to identify a song that matches the song clip, wherein the song clip is an extracted portion of a song file.

10. The method of claim 1, wherein the representation includes is a visual representation of a spectrum of frequencies of the audio track data as it varies with time.

11. The method of claim 1, wherein the transformation function includes a Fast Fourier Transform (FFT).

12. The method of claim 1, wherein the hashing function is adaptive to hash multiple samples into a common hash bucket.

13. The method of claim 1, wherein each peak value includes a maximum peak value in a respective portion of the representation.

14. The method of claim 1, wherein each peak value exceeds a threshold value in a respective portion of the representation.

15. The method of claim 1, wherein a combination of peak values uniquely identifies an audio track from among numerous audio tracks.

16. A method for identifying an audio clip, comprising:
receiving a query including a first audio clip, the first audio clip being input to a user device;
processing the first audio clip to generate a representation of a spectrum of frequencies of the first audio clip as it varies with time;
extracting a plurality of identifiers from the representation, each identifier including a plurality of peak values of the spectrum of frequencies;
comparing identifier data of the first audio clip to identifier data of a plurality of audio clips;
matching the identifier data of the first audio clip to identifier data of a second audio clip of the plurality of audio clips; and
outputting an indication of the second audio clip as a search result that satisfies the query.

17. The method of claim 16 further comprising, prior to outputting the indication of the second audio clip:
hashing the plurality of identifiers, wherein the identifier data of the first audio clip includes hash values of the plurality of identifiers.

18. The method of claim 16, wherein the user device is a handheld mobile device.

19. The method of claim 16, wherein the representation is a spectrogram of the first audio clip.

20. A mobile device comprising:
a processor; and
a memory including processor executable code, wherein the processor executable code upon execution by the processor configures the processor to:
receive a query including a first audio clip, the first audio clip being input to a user device;
process the first audio clip to generate a representation of a spectrum of frequencies of the first audio clip as it varies with time;
extract a plurality of identifiers from the representation, each identifier including a plurality of peak values of the spectrum of frequencies;
compare identifier data of the first audio clip to identifier data of a plurality of audio clips;
match the identifier data of the first audio clip to identifier data of a second audio clip of the plurality of audio clips; and
output an indication of the second audio clip as a search result that satisfies the query;
a microphone coupled to the processor and configured to capture audio;
a display coupled to the processor and configured to display search results; and
a speaker coupled to the processor configured to render the first audio clip or the second audio clip to a user.
